(19) United States
(12) Patent Application Publication
(10) Pub. No.: US 2006/0064710 A1
(43) Pub. Date: Mar. 23, 2006

(54) Optical disk device

(76) Inventors: Chiu-An Huang, Baojhong Township (TW); Chi-Cheng Lin, Taoyuan City (TW)

Correspondence Address: RABIN & Berdo, PC, 1101 14TH STREET, NW, SUITE 500, WASHINGTON, DC, 20005, US

(21) Appl. No.: 11/229,568

(22) Filed: Sep. 20, 2005

(30) Foreign Application Priority Data
Sep. 22, 2004 (TW) 93128775

(51) Int. Cl. G11B 33/14

(52) U.S. Cl. 720/649

(57) ABSTRACT

An optical disk device at least includes a housing, an optical pickup head, a circuit board, and a heat roof. The housing has a ventilating hole. The optical pickup head is disposed in the optical disk device for reading/writing the data on the disk. The circuit board is disposed in the housing. The heat roof is used for separating at least part of the circuit board from the optical pickup head. The heat roof includes a chamber in communication with the ventilating hole. The heat generated from at least part of the circuit board is within the chamber and then diffused to the outside of the optical disk device through the ventilating hole.

This application claims the benefit of Taiwan application Serial No. 93128775, filed Sep. 22, 2004, the subject matter of which is incorporated herein by reference.

### BACKGROUND OF THE INVENTION

1. Field of the Invention

The invention relates to an electric device, and more particularly to a disk device having a heat roof structure.

2. Description of the Related Art

Recently, with the popularization of digital multi-media optical disk, the optical disk device has become an essential product for working and recreation in our daily lives. When the optical disk device is reading/writing the disk, the main motor has to drive the disk spinning continuously. Therefore, the Diver IC has to keep driving the main motor so as to generate high heat.

Nevertheless, the radiant power of the laser diode on the optical pickup head depends on the temperature. Therefore, the over-heated optical disk device will lead to an increase of the temperature around the laser diode, causing inaccurate radiant output from the laser diode. Thus, the optical pickup head may not be able to perform reading/writing of the optical disk. This may result in reading errors of the optical disk device or lower writing quality of the optical disk device. In the long run, this may also influence the lifetime of the optical disk device. Therefore, it is important to lower the temperature inside the optical disk device and maintain the appropriate functional temperature of the optical pickup head.

### SUMMARY OF THE INVENTION

It is therefore an object of the invention to provide an optical disk device to reduce operational temperature effectively. The optical disk device is insulated from the heat source by using a heat roof in order to improve the function of heat radiation in local and avoid the high-temperature air generated by the heat-generating component flowing into the internal optical disk device. Moreover, the circulation air reduces the internal temperature of the optical disk device so as to enhance the performance of the optical disk device and extend the life of usage.

The invention achieves the above-identified object by providing an electric device, which includes: a housing with the ventilating hole, a circuit board having an heat-generating component disposed in an area thereof, a heat roof disposed near the heat-generating component on the circuit board for separating the heat-generating component from the optical pickup head. The heat roof, the housing and the circuit board form a chamber in communication with the ventilating hole. The heat generated from the heat-generating component is within the chamber and then diffused to the outside of the electric device through the ventilating hole.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a three-dimension exploded drawing of an optical disk device according to a first embodiment of the invention.

FIG. 2 is a perspective view of the optical disk device according to the first embodiment of the invention.

FIG. 3A is a top view of the optical disk device according to the first embodiment of the invention.

FIG. 3B is a side view of the optical disk device according to the first embodiment of the invention.

FIG. 4 is a cross-sectional view of the optical disk device according to the first embodiment of the invention.

FIG. 5 is a schematic diagram illustrating the flow direction of the heat air according to the first embodiment of the invention.

FIG. 6 is a cross-sectional view of the optical disk device according to a second embodiment of the invention.

### DETAILED DESCRIPTION OF THE INVENTION

The design of the invention is mainly based on the heat roof structure disposed inside the electric device for insulating the heat-generating component inside the optical disk device from the components whose function is likely to be influenced by high temperature. Also, the design improves the heat radiation in local and reduces the ambient temperature of the operational environment, thereby enhancing the overall efficiency of the electric device. The scope of the invention is not limited to the examples described as follows. The following embodiments of the optical disk device are taken as examples to illustrate the spirit of the invention.

### First Embodiment

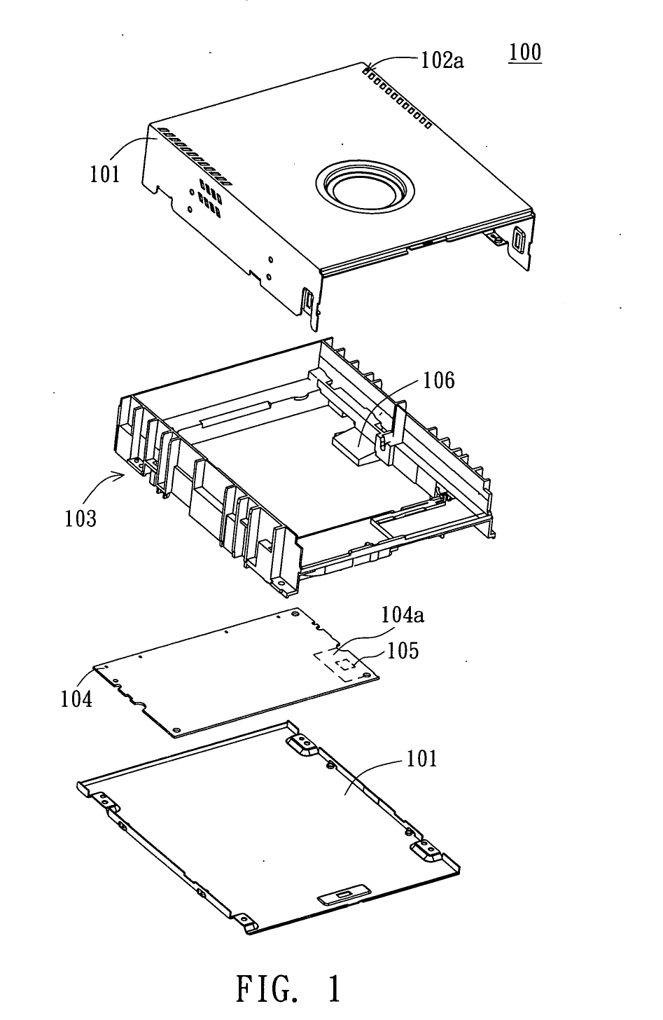

Referring to FIG. 1, a three-dimension exploded drawing of the optical disk device according to a first embodiment of the invention is shown. The optical disk device 100 at least includes: a housing 101, an optical pickup head (not shown in the drawings), a chassis 103, a circuit board 104 and a heat roof 106. The housing 101 has the ventilating holes 102a and 102b. The chassis 103 is disposed inside the optical disk device 100. The optical pickup head is disposed inside the housing 101 for reading/writing the data on the disk. The circuit board 104 has a heat-generating component, such as a Driver IC 105 (shown in dashed line). The Driver IC 105 is disposed in the area 104a of the circuit board 104, such as on the bottom or at one side of the circuit board 104. The Driver IC 105 is used to drive the main motor. The Driver IC 105 can further drive the stepping motor of the optical pickup head and the tray motor for moving the tray in and out of the optical disk device. Therefore, the Driver IC 105 generates a large quantity of heat while driving these motors. The heat roof 106 is positioned near the Driver IC 105 of the circuit board 104 and covers up the area 104a of the circuit board 104.

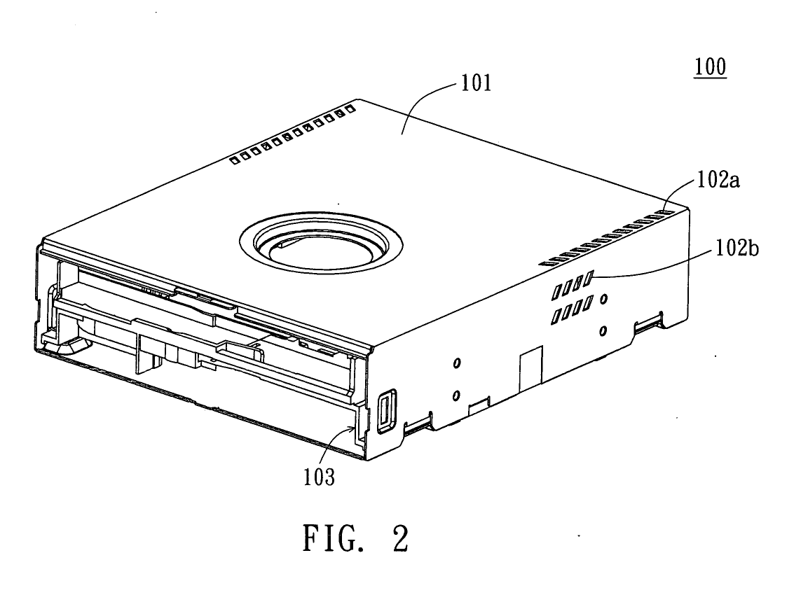

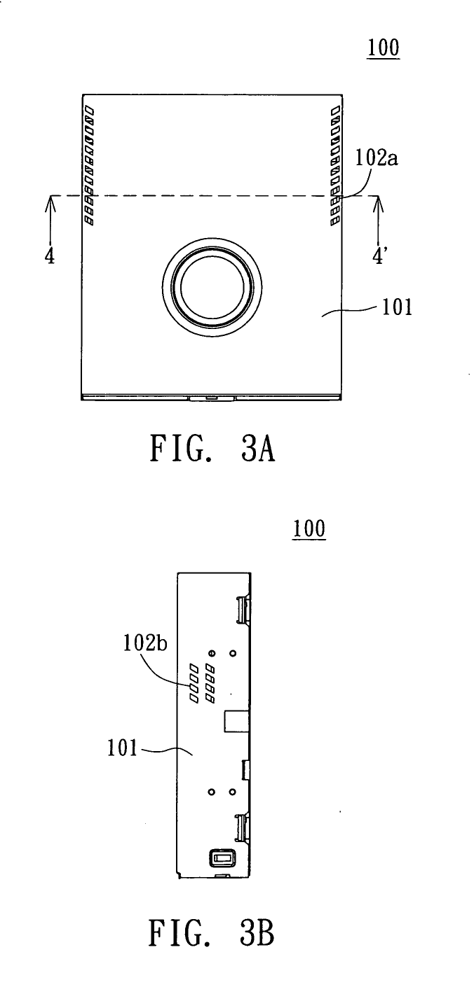

Referring to FIGS. 2˜3B, FIG. 2 is a perspective view of the optical disk device, FIG. 3A is a top view of the optical disk device, and FIG. 3B is a side view of the optical disk device according to the first embodiment of the invention. The top of the housing 101 has ventilating hole 102a, and the lateral of the housing 101 has ventilating hole 102b.

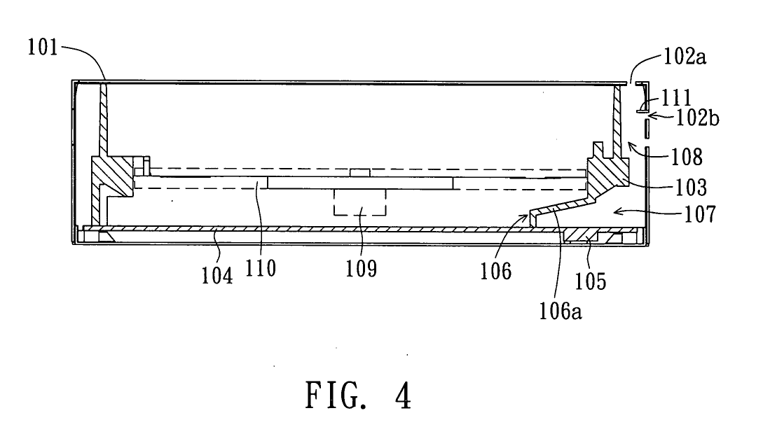

Refer to FIG. 4, which is a cross-sectional drawing of the optical disk device viewed along the arrow direction according to the hatched line of the FIG. 3. The Driver IC 105 is centrally disposed in an area of the circuit board 104 (not shown in the drawings). Preferably, the area (not shown) is located at one side of the circuit board 104 near the ventilating holes 102a and 102b in the housing 101. One end of the heat roof 106 is disposed on the chassis 103, and another end is against the circuit board 104. The chamber 107 is formed by the heat roof 106 and the circuit board 104. The heat roof 106 is used to insulate the optical pickup head 109 (shown in dashed line) from the heat generated by at least part of the circuit board 104, such as the Driver IC 105 and its surroundings of the circuit board 104. The chamber 107 of the heat roof is in communication with the ventilating holes 102a and 102b. The channel 108 formed by the chassis 103 and the housing 101 is in communication with the chamber 107.

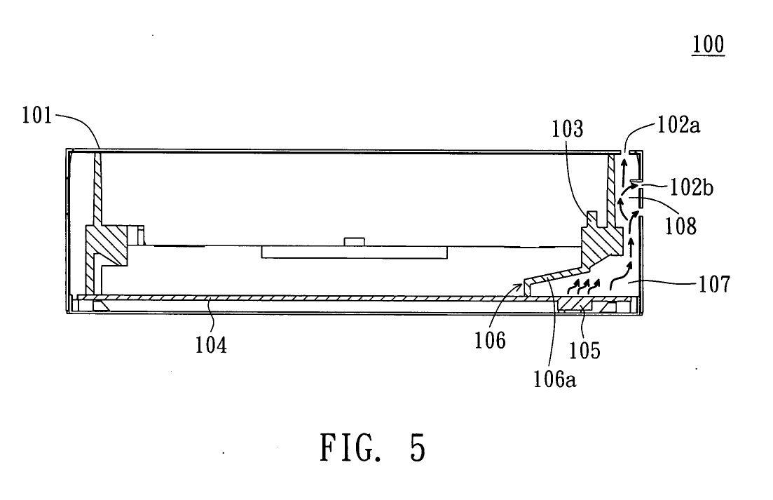

FIG. 5 is a schematic diagram illustrating the flow direction of the heat air according to the first embodiment of the invention. The heat produced by the Driver IC 105 is transmitted to the channel 108 and diffused to the outside of the optical disk device 100 through the ventilating holes 102a and 102b. Therefore, the heat generated from at least part of the circuit board 104, like Driver IC 105, can be diffused to the outside of the optical disk device 100.

As shown in FIG. 4, the optical disk device 100 further includes the traverse (shown in dashed line), movably disposed on the chassis 103 for carrying the pickup head 109 (shown in dashed line) to ascend and descend. The heat roof 106 has an inclined surface 106a facing the traverse 110. The inclined surface 106a of the heat roof is used to allocate space, so that the traverse 110 can ascend and descend inside the optical disk device without colliding with the heat roof 106.

As shown in FIG. 4, in this case, the ventilating hole 102b possesses a blade 111 and has functions of dust-resistant and airflow leading. Moreover, the chassis 103 and the heat roof 106 are integrally formed.

### Second Embodiment

The difference between the optical disk device 200 of the present embodiment and the optical disk device 100 of the first embodiment is the connection relationship between the heat roof and the components of the optical disk device. Components and the reference numbers used in the first embodiment and the second embodiment are the same.

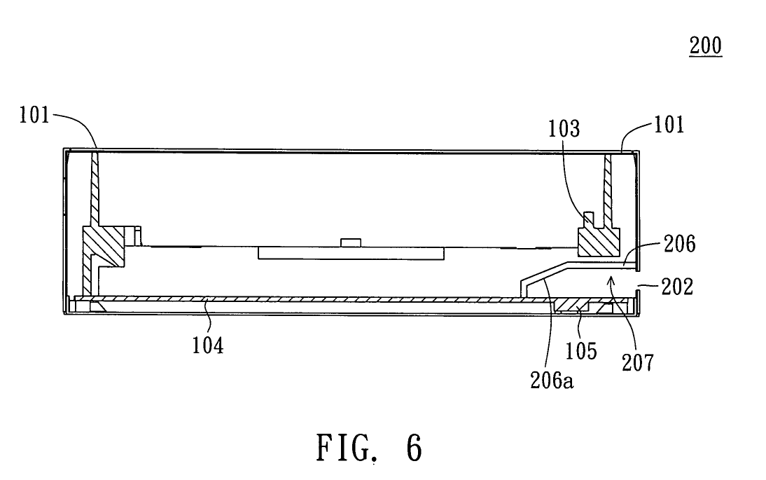

Referring to FIG. 6, a cross-sectional view of the optical disk device according to the second embodiment of the invention is shown. Inside the optical disk device 200, one end of the heat roof 206 is connected to the housing 101 and another end is against the circuit board 104. The heat roof 206 connects the housing 101 and the circuit board 104, for separating the optical pickup head 106 from the Driver IC 105. Besides, the chamber 207 is formed by the heat roof 206, the circuit board 104, and the housing 101, for insulating the optical pickup head 106 from heat generated by the Driver IC 105 so as to prevent the operation temperature of the optical disk device from rising due to the heat diffusion into the entire inner optical disk device. Moreover, the housing has the ventilating hole 202 disposed on the lateral thereof for being in communication with the chamber 207 of the inside optical disk device and the outside of the optical disk device. Accordingly, the heat generated from part of the circuit board 104, such as the Driver IC 105, is transmitted to the chamber 207 and diffused to the outside of the optical disk device through the ventilating hole 202.

Furthermore, the scope of the invention is not limited to the example of the heat roof described above. Alternatively, the heat roof covering up an area of the circuit board can have one end connected to the circuit board and another end extending against the housing.

The optical disk device according to the aforementioned embodiments has functions of dust-resistant and airflow leading. By using the heat roof, the optical pickup head can be insulated from plenty of heat generated by the heat-generating component. Besides, the air circulates through the chamber the ventilating hole on the housing, and the outside, so as to reduce the internal temperature of the optical disk device, thereby enhancing the performance of the optical disk device and extending the life of usage of the optical disk device. In addition, the heat roof can be integrally formed with the chassis without additional manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electric device comprising:
a housing having a ventilating hole;
a circuit board disposed in one side of the housing; and
a heat roof, wherein the heat roof, the housing and the circuit board form a chamber in communication with the ventilating hole so that heat generated from at least part of the circuit board is within the chamber and then diffused to outside of the electric device through the ventilating hole.

2. The electric device according to claim 1 further comprising a heat-generating component disposed in an area of the circuit board.

3. The electric device according to claim 2, wherein the area is positioned at one side of the circuit board near the ventilating hole in the housing so that heat generated from the heat-generating component is diffused to the outside of the electric device through the chamber and the ventilating hole.

4. The electric device according to claim 2, wherein the heat-generating component is disposed on a bottom of the circuit board.

5. The electric device according to claim 2, wherein the heat roof is disposed adjacent to the heat-generating component on the circuit board.

6. The electric device according to claim 2, wherein the heat roof covers the area of the circuit board.

7. The electric device according to claim 2 further comprising a chassis, one end of the heat roof disposed on the chassis, another end against the circuit board.

8. The electric device according to claim 7 being a disk drive, further comprising:
a pickup head disposed inside the housing for reading data on a disk; and
a traverse movably disposed on the chassis for carrying the pickup head to ascend and descend, wherein the heat roof has an inclined surface facing the traverse.

9. The electric device according to claim 8, wherein the heat roof separates the heat-generating component from the pickup head,

10. The electric device according to claim 7, wherein the chassis is formed integrally with the heat roof.

11. The electric device according to claim 7, wherein the chassis and the housing form a channel in communication with the chamber, and wherein heat generated from the at least part of the circuit board is transmitted to the channel and diffused to the outside of the electric device through the ventilating hole.

12. The electric device according to claim 1, wherein the ventilating hole is disposed on a top of the housing.

13. The electric device according to claim 1, wherein the ventilating hole is disposed on a lateral of the housing.

14. The electric device according to claim 1, wherein the ventilating hole is equipped with a blade.

15. The electric device according to claim 2, wherein one end of the heat roof is connected to the housing and another end extends against the circuit board.

16. The electric device according to claim 15 being a disk drive, further comprising:
a pickup head disposed inside the housing for reading data on a disk; and
a traverse movably disposed in the housing for carrying the pickup head, the heat roof having an inclined surface facing the traverse.

17. The electric device according to claim 16, wherein the heat roof separates the heat-generating component from the pickup head,

18. The electric device according to claim 2, wherein one end of the heat roof is connected to the circuit board, another end extends against the housing, and the heat roof covering up the area of the circuit board.

19. The electric device according to claim 18 being a disk drive, further comprising:
a pickup head disposed inside the housing for reading data on a disk; and
a traverse movably disposed in the housing for carrying the pickup head, the heat roof having an inclined surface facing the traverse.

20. The electric device according to claim 19, wherein the heat roof separates the heat-generating component from the pickup head.
